(19) United States
(12) Patent Application Publication
(10) Pub. No.: US 2026/0343656 A1
(43) Pub. Date: Oct. 29, 2026

(54) SYSTEMS AND METHODS FOR ADAPTIVE SUBSCRIPTION CONCEALED IDENTIFIER (SUCI) CALCULATION IN A TELECOMMUNICATIONS DEVICE

(71) Applicant: T-MOBILE INNOVATIONS LLC, Overland Park, KS (US)

(72) Inventors: Cody Lee TAYLOR, North Bend, WA (US); Kyeong Hun AN, Sammamish, WA (US)

(21) Appl. No.: 19/189,849

(22) Filed: Apr. 25, 2025

(51) Int. Cl. H04W 76/18; H04W 8/18; H04W 12/06; H04W 12/72

(52) U.S. Cl. CPC H04W 76/18; H04W 8/183; H04W 12/06; H04W 12/72

(57) ABSTRACT

Systems and methods are provided for dynamically switching the SUCI calculation in a UE to improve network authentication. The UE generates a SUCI using a first method, either via the SIM or the UE, and transmits it for authentication. If authentication fails due to a SUCI calculation error, the UE reads the UST entry 125 on the SIM to determine the current method and dynamically modifies the UST entry 125 setting to switch SUCI calculation to an alternative method. The UE then reattempts authentication using the updated method.

### SUMMARY

A high-level overview of various aspects of the invention is provided herein, to introduce a selection of concepts that are further described in the detailed-description section below. This summary is not intended to identify key features or essential features of the claimed subject matter, nor is it intended to be used as an aid in isolation to determine the scope of the claimed subject matter.

In aspects set forth herein, systems and methods are provided for improving authentication processes in telecommunications networks. The present disclosure describes a mechanism for dynamically adjusting authentication parameters in response to specific conditions.

### BRIEF DESCRIPTION OF THE SEVERAL VIEWS OF THE DRAWINGS

Implementations of the present disclosure are described in detail below with reference to the attached drawing figures, wherein:

FIG. 1 depicts an exemplary environment suitable for use in implementations of the present disclosure, in accordance with aspects herein;

FIG. 2 depicts a flowchart for dynamic SUCI switching, in accordance with aspects herein;

FIG. 3 depicts a UST entry 125 state diagram, in accordance with aspects herein;

FIG. 4 depicts an exemplary flow diagram in accordance with embodiments described herein; and

FIG. 5 depicts an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. Further, various technical terms are used throughout this description. An illustrative resource that fleshes out various aspects of these terms can be found in Newton's Telecom Dictionary, 22d Edition (2022).

As used herein, the term “node” refers to any network access technology that facilitates the provision of wireless telecommunication service from a base station to one or more electronic devices. In various embodiments, a node may include, but is not limited to, an eNodeB, gNodeB, or any other radio access network (RAN) component that enables communication between a UE and the core network. In alternative embodiments, the term “node” may also encompass non-traditional access points, such as Wi-Fi access points, femtocells, picocells, and distributed antenna system components.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

As used herein, a UE (also referenced herein as a user device) or WCD (wireless communication device) can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

As used herein, a Subscription Concealed Identifier (SUCI) is a privacy-preserving identifier derived from a Subscription Permanent Identifier (SUPI) using encryption techniques. The SUCI is transmitted by a UE during network authentication to prevent exposure of the SUPI over unprotected radio links. The SUCI can be generated by either a SIM card or the UE, depending on configuration settings.

As used herein, a Subscription Permanent Identifier (SUPI) is a unique identifier assigned to a mobile subscriber by a network operator. The SUPI serves as the primary identity of a subscriber within a 5G network and is typically stored on the SIM card. To enhance security, the SUPI is never transmitted in plain text over the air and is instead used to generate the SUCI.

As used herein, a Subscriber Identity Module (SIM) is a secure hardware component that stores subscriber-related information, including the SUPI, authentication keys, and network access parameters. The SIM may be a physical SIM, an embedded SIM (eSIM), or a virtual SIM. In certain implementations, the SIM is responsible for generating the SUCI before transmission to the network.

As used herein, a Universal SIM Service Table (UST) is a data structure stored on a SIM card that defines various operational settings for authentication and network access. UST entry 125, in particular, controls whether SUCI computation is performed by the SIM or the UE. Modifying UST 125 allows for dynamic switching between SUCI computation methods in response to authentication failures.

As used herein, authentication refers to the process by which a UE verifies its identity with a telecommunications network. This process typically involves the exchange of cryptographic credentials between the UE, SIM, and network authentication functions (e.g., AUSF in a 5G Core Network). Authentication failures can occur due to misconfigured network settings, encryption mismatches, or incorrect SUCI computation.

By way of background, mobile devices authenticate with 5G networks using a SUCI, which is derived from a SUPI, for privacy protection. The SUCI can be calculated either by the SIM card or by the UE, depending on network and device configurations. However, authentication failures may occur due to incorrect SUCI computation, misconfigured network policies, SIM profile errors, device-side processing issues, and the like. When these failures happen, the device is rejected by the network, preventing connectivity and disrupting service for the user.

Conventionally, devices are preconfigured to perform SUCI calculations in either the SIM or the UE, with no mechanism to adaptively switch between these methods if authentication failures occur. When a SUCI-related failure happens, the typical solutions involve manual troubleshooting, SIM card replacement, or network-side intervention, all of which are inefficient, time-consuming, and disruptive to users. Additionally, network operators may need to issue firmware updates or reconfigure authentication settings, further delaying resolution.

Unlike conventional solutions, the present disclosure is directed to systems and methods that dynamically switch the SUCI calculation between the SIM card and the UE in response to authentication failures. Specifically, the UE detects authentication failures, reads the UST entry 125, and modifies the UST setting to switch the SUCI calculation from one method to another. This switching process occurs automatically without requiring user intervention and thereby enhances network connectivity reliability for the user.

Accordingly, a first aspect of the present disclosure is directed to a method for dynamically switching authentication parameters in a user device (UE). The method includes initiating a network connection request from a UE to a telecommunications network using a subscriber identity module (SIM) card. A subscription concealed identifier (SUCI) is generated using the SIM card and transmitted to the telecommunications network for authentication. If the authentication request is rejected due to a SUCI calculation error, the UE reads a universal SIM service table (UST) to determine whether the SUCI calculation is set to be performed by the SIM or by the UE. Based on this determination, the method further includes dynamically modifying the UST setting to adjust the SUCI calculation method and reattempting the network connection request using the modified calculation method.

A second aspect of the present disclosure is directed to a system for dynamically switching authentication parameters in a user equipment (UE). The system includes the UE comprising a subscriber identity module (SIM) card, one or more processors, and one or more computer-readable media storing computer-usable instructions. When executed by the one or more processors, these instructions cause the UE to initiate a network connection request using the SIM card, generate a subscription concealed identifier (SUCI) using the UE, and transmit the SUCI to the telecommunications network for authentication. If the authentication request is rejected due to a SUCI calculation error, the system reads a universal SIM service table (UST) to determine whether the SUCI calculation is set to be performed by the SIM or the UE. The system then dynamically modifies the UST setting to adjust the SUCI calculation method and reattempts the network connection request using the modified calculation method.

Another aspect of the present disclosure is directed to a computer-readable medium storing instructions that, when executed by a processor, cause the processor to perform a method for enabling communication by dynamically adjusting authentication parameters in a telecommunications network. The method includes initiating a network connection request from a user equipment (UE) to a telecommunications network, generating a subscription concealed identifier (SUCI) using a first SUCI calculation method, and transmitting the SUCI to the telecommunications network for authentication. If the authentication request is rejected due to a SUCI calculation error, the method further includes reading a universal subscriber identity module (SIM) service table (UST) to determine whether the SUCI calculation is currently performed using the first SUCI calculation method or a second SUCI calculation method. The UST setting is then dynamically modified to switch from the first SUCI calculation method to the second SUCI calculation method, and the network connection request is reattempted using the modified calculation method.

In some embodiments, the systems and methods described herein may also be applied to non-terrestrial networks (NTNs), including satellite-based communication systems operating in low Earth orbit (LEO), medium Earth orbit (MEO), or geostationary orbit (GEO). In such environments, a UE may initiate authentication while connected via a satellite link, where challenges such as increased latency, intermittent coverage, and long round-trip times may affect the timing and reliability of SUCI-based authentication. The disclosed ability of the UE to read and modify the UST entry on the SIM to switch between SIM-based and UE-based SUCI calculation enables more resilient authentication handling under varying satellite link conditions.

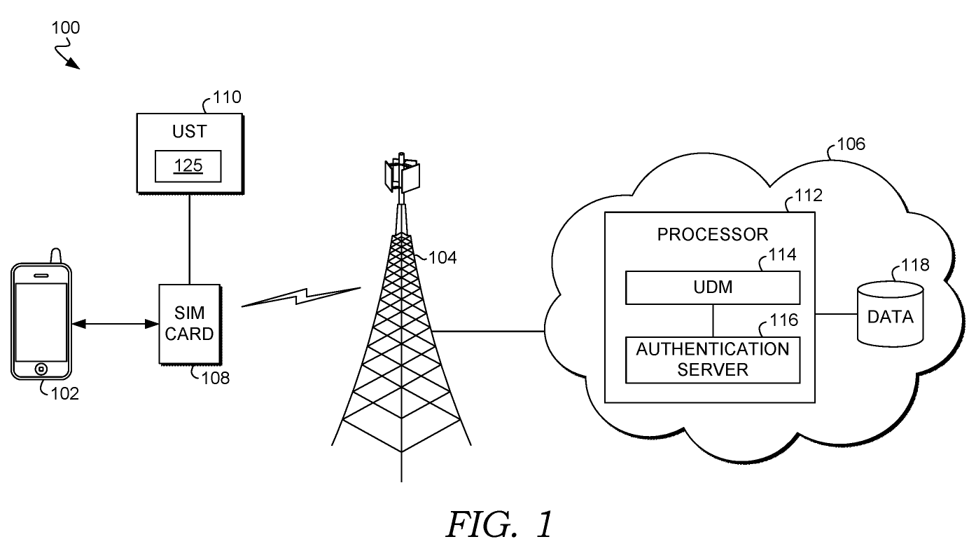

Turning to FIG. 1, a network environment 100 suitable for implementing embodiments of the present disclosure is provided. The network environment 100 represents a wireless communication system that enables dynamic switching of the SUCI calculation method in response to network connection failures. While FIG. 1 provides a simplified example, it should be understood that network environment 100 may incorporate additional network elements, interfaces, and configurations to accommodate different deployment scenarios. The network environment 100 generally comprises a UE 102, a base station 104, and a core network 106. The UE 102 communicates wirelessly with the base station 104, which facilitates access to the core network 106 for authentication and service provisioning.

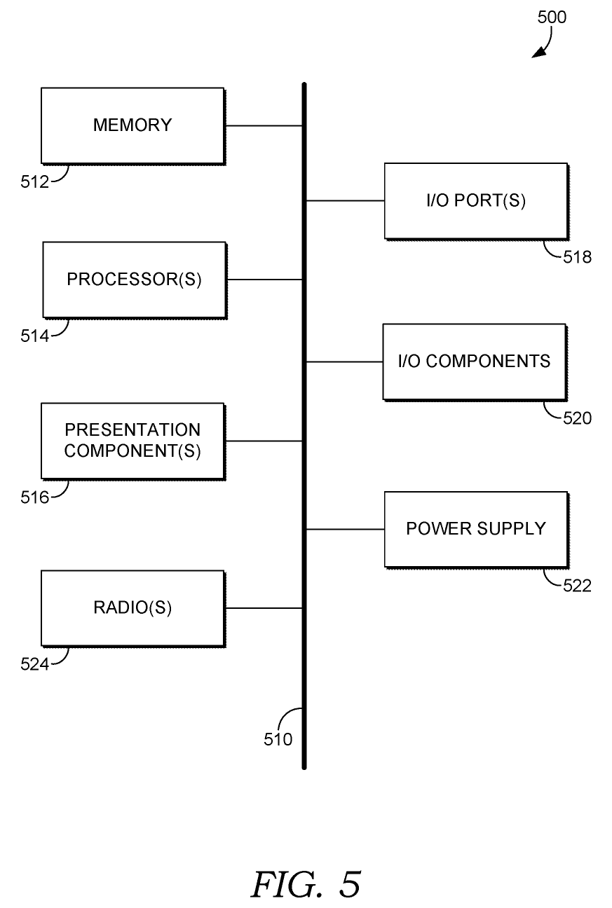

The network environment 100 comprises at least a UE 102, having any one or more aspects of the computing device 500 of FIG. 5. The telecommunications network environment 100 may include an array of devices or components, some of which are not shown to avoid obscuring more relevant aspects of the invention. Components such as terminals, links, access points, and nodes (as well as other components) may provide connectivity in some embodiments. The network may include multiple networks. The network may be part of a telecommunications network that connects subscribers to their immediate service provider. In the network environment 100, the UE 102 may communicate with other devices, such as mobile devices, servers, etc.

The UE 102 represents a mobile device, such as a smartphone, tablet, wearable device, or Internet of Things (IoT) system, configured to establish a connection with a wireless telecommunications network. The UE 102 includes a SIM 108, which securely stores subscriber credentials, cryptographic keys, and authentication parameters required for network access. To establish network connectivity, the UE 102 initiates a network connection request. In aspects, the UE 102 may initiate the network connection request by calculating the SUCI using a first method (e.g., the credentials stored within the SIM 108) or an alternative method (e.g., the credentials stored within the UE 102).

The SIM 108 contains a UST 110, which defines the method for SUCI computation—determining whether the SUCI is generated by the SIM 108 or by the UE 102. When authentication is required, the UE 102 reads the UST 110 from the SIM 108 to determine the current SUCI computation method. If authentication fails due to a SUCI calculation error, the UE 102 may modify the UST 110 setting on the SIM 108, allowing the UE 102 to dynamically switch between SIM-based and UE-based SUCI computation as needed. The UE 102 may then reattempt the network connection request using the modified SUCI calculation method.

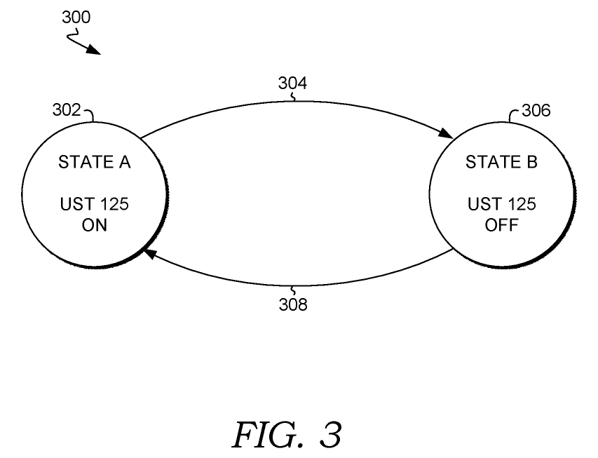

The UST 110 includes a designation of whether the SUCI calculation is performed by the SIM 108 or the UE 102, illustrated in FIG. 1 as entry 125 (e.g., Service n°125). When the entry 125 is in an “on” state, the SIM 108 is configured to perform SUCI calculations. Alternatively, when the entry 125 is in an “off” state, the SUCI calculation is performed by the UE 102. In aspects, if an authentication failure occurs, the UE 102 may dynamically modify the entry 125 to toggle between these two states (e.g., on and off, as depicted in FIG. 3). In some embodiments, the entry 125 may be modified no more than a predetermined number of times within a given time period to prevent excessive switching between SUCI calculation methods. For example, modifying the UST 110 setting may be performed after detecting at least two consecutive SUCI calculation errors within a predetermined period of time. Additionally, the UE 102 may wait for a predetermined time period, such as five minutes, before reattempting authentication after modifying the entry 125. In various embodiments, if the authentication request fails after a pre-determined number of modifications to entry 125, the UE 102 may send an error notification to a network operator.

Still referring to FIG. 1, the base station 104 serves as a radio access network node, facilitating wireless communication between the UE 102 and the core network 106. The base station 104 is configured to forward authentication requests from the UE 102 to the core network 106, ensuring that subscriber identities are properly verified before granting the UE 102 network access. Depending on the implementation, the base station 104 may correspond to a 5G gNodeB, an LTE eNodeB, or other cellular access infrastructure.

The core network 106, represented in FIG. 1 as a cloud-based infrastructure, is responsible for processing authentication requests and enabling seamless access control. The core network 106 includes a processor 112, which coordinates authentication procedures and dynamically adjusts the settings on the UST 110 when required. Within the processor 112, a unified data management (UDM) module 114 maintains subscriber identity records, policy enforcement rules, and encryption keys. Also within the processor 112 is an authentication server 116, which processes incoming authentication requests and validates whether the received SUCI corresponds to an authorized subscriber. Additionally, a data storage module 118 securely retains cryptographic parameters, subscriber profiles, and authentication logs for verification and fraud detection.

During authentication, the UE 102 generates a SUCI, which is an encrypted version of the SUPI used to protect subscriber privacy. The method used to generate the SUCI is dictated by the UST 110, which determines whether the encryption is performed by the SIM 108 or by the UE 102 itself. If the UST 110 is configured for SIM-based SUCI calculation, the SIM 108 performs the encryption and transmits the SUCI to the base station 104. Alternatively, if the UST 110 is configured for UE-based SUCI calculation, the UE 102 directly performs the encryption before sending the SUCI to the base station 104. The base station 104 then relays the authentication request to the core network 106, where the authentication server 116 processes the request by extracting the SUCI and querying the UDM module 114 for validation.

If the authentication request fails due to a SUCI calculation error, the processor 112 may initiate a correction mechanism by referencing the UST 110 stored on the SIM 108. If a discrepancy in the SUCI calculation method is detected, the processor 112 may instruct the UE 102 to modify the entry 125 to switch the SUCI calculation method. If the entry 125 was previously in the “on” state, meaning the SIM 108 was performing the SUCI calculation, the UE 102 may modify the entry 125 to the “off” state, thereby switching the SUCI calculation responsibility to the UE 102. If the entry 125 was initially in the “off” state, meaning the UE 102 was performing the SUCI calculation, the UE 102 may modify the entry 125 to the “on” state, restoring the SUCI calculation process to the SIM 108.

Once the UST 110 setting is updated, the UE 102 may generate a new SUCI using the alternative calculation method and reattempt authentication. This process continues until authentication is successful or a predetermined number of SUCI modification attempts have been exhausted, at which point the UE 102 may send an error notification to a network operator. The notification may include diagnostic information, such as the number of SUCI switching attempts, the reason for authentication failure, and network conditions.

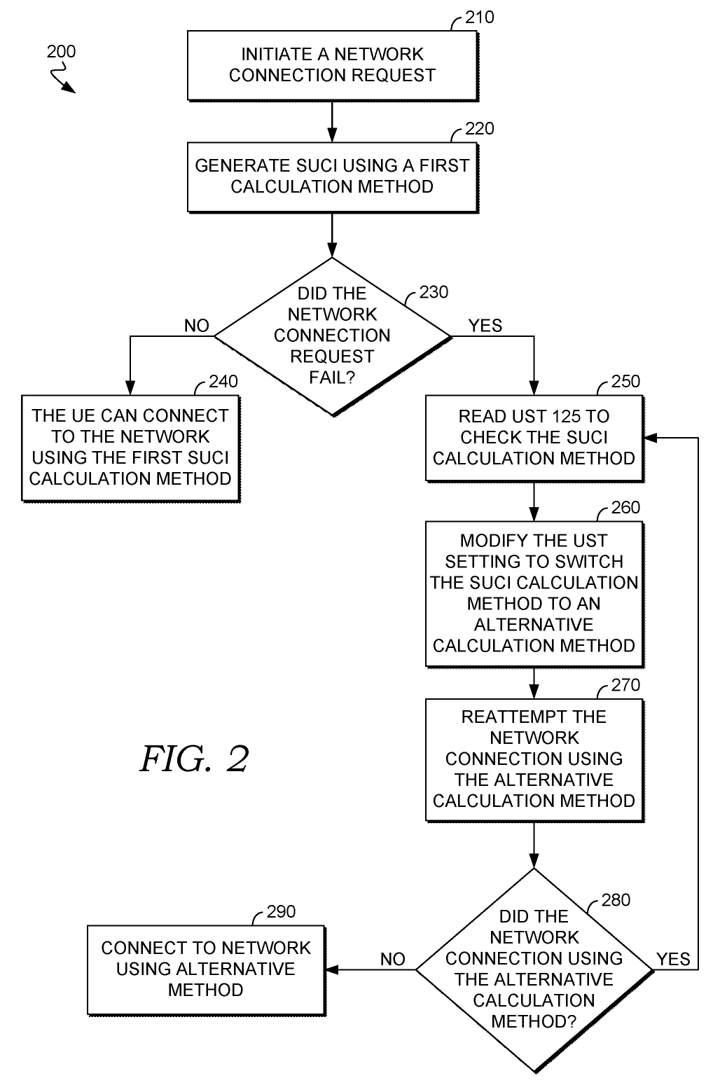

Turning to FIG. 2, a flowchart 200 illustrates flowchart for the SUCI calculation in response to network authentication failures. The process begins at step 210, where a UE initiates a network connection request. At step 220, the UE generates a SUCI using a first calculation method, which may be performed by either the SIM card or the UE itself, depending on the settings stored in the UST 125. The SUCI is then transmitted to the network for authentication.

At step 230, a determination is made as to whether the network connection request was successful. If the authentication is successful, the process concludes at step 240, allowing the UE to connect to the network using the first SUCI calculation method. However, if the network connection request fails, the process proceeds to step 250, where the UE reads UST 125 to determine the currently designated SUCI calculation method. Based on this information, the UE dynamically modifies the UST 125 setting at step 260, switching to an alternative SUCI calculation method (e.g., from SIM-based to UE-based or vice-versa).

Following the UST 125 modification, the UE reattempts the network connection at step 270, utilizing the newly selected SUCI calculation method. At step 280, another determination is made as to whether the authentication request was successful. If the authentication succeeds, the process concludes at step 290, and the UE is granted network access using the second SUCI calculation method. If the authentication attempt fails again, the process loops back to step 250, where the UST 125 is read again, and the SUCI calculation method is switched back to the first method at step 260 before another connection attempt is made.

Turning to FIG. 3, a state diagram is illustrated depicting the modification process of UST 125 to dynamically switch between the two SUCI calculation methods in response to authentication failures. The diagram represents the transition between two states: State A 302, where SUCI is calculated by the SIM, and State B 306, where SUCI is calculated by the UE.

In State A 302, the UST 125 is “on,” which means it is set to enable SUCI calculation by the SIM. If the network authentication request is successful, the UE remains in this state (e.g., State A 302), and no modifications to UST 125 are necessary. However, if authentication fails 304, the UE reads UST 125 and determines that the SUCI calculation should be switched to an alternative method. The UST 125 setting is modified, transitioning the system to State B 306, wherein the UST 125 is “off” and the UE itself performs the SUCI computation instead of the SIM.

Once in State B 306, the UE reattempts authentication using the newly selected calculation method. If authentication is successful, the UE remains in this state, continuing to use the UE-based SUCI computation for subsequent authentication requests. However, if the authentication request fails again 308, the system recognizes the repeated failure and reverts UST 125 back to its initial configuration, returning to State A 302, where SUCI computation is once again handled by the SIM.

In aspects, to mitigate excessive switching between states, a failsafe mechanism may be implemented to limit the number of transitions within a predefined time frame. For example, the system may restrict the number of UST 125 modifications within a given period to prevent unnecessary network load and potential signaling issues.

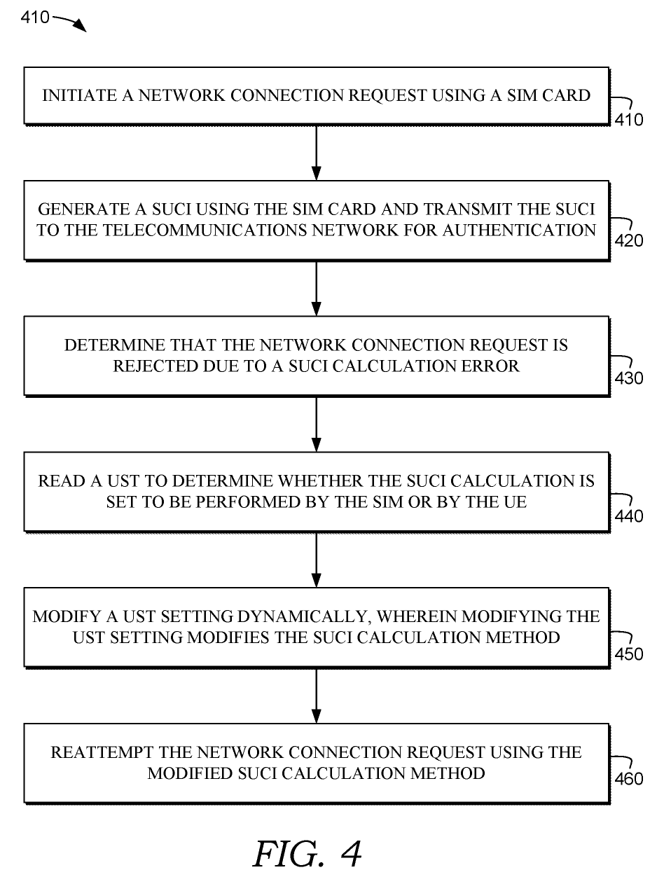

Turning now to FIG. 4, an exemplary flow diagram 400 is shown in accordance with embodiments. In this example, a computerized system, such as a UE, initiates a network connection request using a SIM card at step 410. At step 420, the UE generates a SUCI using the SIM card and transmits the SUCI to the telecommunications network for authentication. The SUCI ensures that subscriber privacy is maintained while allowing network authentication to take place. At step430, the UE determines whether the authentication request is successful or rejected due to a SUCI calculation error. If authentication is successful, the UE establishes a connection with the network, and no further modifications to the SUCI calculation method are required.

If the authentication request is rejected, at step 440, the UE reads the universal SIM service table (UST 125) to determine whether the SUCI calculation is currently set to be performed by the SIM card or by the UE itself. Based on the UST 125 setting, at step 450, the UE dynamically modifies the UST entry to switch the SUCI calculation method from the current method to an alternative method. If the SUCI was previously generated by the SIM card, the setting is updated to use the UE for SUCI calculation, and vice versa. At step 460, the UE reattempts the network connection request using the modified SUCI calculation method. The authentication request is transmitted once again, now using the alternative SUCI computation approach.

If authentication is successful, the UE may establish a connection with the network, and no further modifications to the UST 125 setting are needed. In aspects, if the authentication request fails again, the UE may evaluate whether additional retries should be attempted or whether an error notification should be sent to the network operator.

In FIG. 5, a diagram is depicted of an exemplary computing environment suitable for use in implementations of the present disclosure. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 510 that directly or indirectly couples the following devices: memory 512, one or more processors 514, one or more presentation components 516, input/output (I/O) ports 518, I/O components 520, power supply 522 and radio(s) 524. Bus 510 represents what may be one or more busses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component, such as a display device to be one of I/O components 520. Also, processors, such as one or more processors 514, have memory. The present disclosure hereof recognizes that such is the nature of the art and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 512 includes computer-storage media in the form of volatile and/or nonvolatile memory. Memory 512 may be removable, non-removable, or a combination thereof. Exemplary memory includes solid-state memory, hard drives, optical-disc drives, etc. Computing device 500 includes one or more processors 514 that read data from various entities, such as bus 510, memory 512, or I/O components 520. One or more presentation components 516 presents data indications to a person or other device. Exemplary examples of one or more presentation components 516 include a display device, speaker, printing component, vibrating component, etc. I/O ports 518 allow computing device 500 to be logically coupled to other devices, including I/O components 520, some of which may be built in computing device 500. Illustrative I/O components 520 include a microphone, joystick, game pad, satellite dish, scanner, printer, wireless device, etc.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A method for dynamically switching a subscription concealed identifier (SUCI) calculation in a user equipment (UE), the method comprising:
initiating a network connection request to a telecommunications network using a subscriber identity module (SIM) card;
generating a SUCI using the SIM card and transmitting the SUCI to the telecommunications network for authentication;
determining that the network connection request is rejected due to a SUCI calculation error;
reading a universal SIM service table (UST) to determine whether the SUCI calculation is set to be performed by the SIM or by the UE;
modifying a UST setting dynamically, wherein modifying the UST setting modifies the SUCI calculation method; and
reattempting the network connection request using the modified SUCI calculation method.

2. The method of claim 1, wherein the UST setting is UST entry 125.

3. The method of claim 2, wherein modifying the UST setting comprises changing the UST entry 125 between an on state and an off state, wherein when UST entry 125 is on the SIM performs the SUCI calculation and when UST entry 125 is off the UE performs the SUCI calculation.

4. The method of claim 3, wherein the UST entry 125 is modified no more than a predetermined number of times within a predetermined time period.

5. The method of claim 3, wherein if the authentication request fails after a pre-determined number of modifications to UST entry 125, the UE sends an error notification to a network operator.

6. The method of claim 2, wherein after modifying UST entry 125, the UE waits for a pre-determined amount of time before reattempting the network connection request.

7. The method of claim 6, wherein the pre-determined amount of time is five minutes.

8. The method of claim 1, wherein modifying the UST setting is performed after detecting at least two consecutive SUCI calculation errors within a predetermined period of time.

9. A system for dynamically switching a subscription concealed identifier (SUCI) calculation in a user equipment (UE), the system comprising:
the UE comprising:a subscriber identity module (SIM) card;one or more processors; andone or more computer-readable media storing computer-usable instructions that, when executed by the one or more processors, cause the one or more processors to:initiate a network connection request to a telecommunications network;calculate a SUCI using the UE and transmit the SUCI to the telecommunications network for authentication;determine that the authentication request is rejected due to a SUCI calculation error;read a universal SIM service table (UST) to determine whether the SUCI calculation is set to be performed by the SIM or the UE;modify a UST setting dynamically to enable SUCI calculation by the SIM instead of the UE; and reattempt the network connection request using the modified SUCI calculation method.

10. The system of claim 9, wherein the UST setting is UST entry 125.

11. The system of claim 10, wherein modifying the UST setting comprises changing the UST entry 125 between an on state and an off state, wherein:
when UST entry 125 is on the SIM performs the SUCI calculation; and
when UST entry 125 is off the UE performs the SUCI calculation.

12. The system of claim 11, wherein the UST entry 125 is modified no more than a predetermined number of times within a predetermined time period.

13. The system of claim 11, wherein if the authentication request fails after a pre-determined number of modifications to UST entry 125, the UE sends an error notification to a network operator.

14. The system of claim 10, wherein after modifying UST entry 125, the UE waits for a pre-determined amount of time before reattempting the network connection request.

15. The system of claim 9, wherein modifying the UST setting is performed after detecting at least two consecutive SUCI calculation errors within a predetermined period of time.

16. Computer-readable storage media having computer-executable instructions embodied thereon that, when executed by one or more processors, cause the one or more processors to:
initiate a network connection request to a telecommunications network;generate a subscription concealed identifier (SUCI) using a first SUCI calculation method and transmit the SUCI to the telecommunications network for authentication;determine that the network connection request is rejected due to a SUCI calculation error;read a universal subscriber identity module (SIM) service table (UST) to determine a UST setting, wherein the UST setting indicates whether the SUCI calculation is currently performed using the first SUCI calculation method or a second calculation method;modify the UST setting dynamically to switch the SUCI calculation method from the first SUCI calculation method to the second SUCI calculation method; and reattempt the network connection request using the second SUCI calculation method.

17. The computer-readable media of claim 16, wherein the first SUCI calculation method is performed by a SIM card and the second SUCI calculation method is performed by the UE.

18. The computer-readable media of claim 16, wherein the first SUCI calculation method is performed by the UE and the second SUCI calculation method is performed by a SIM card.

19. The computer-readable media of claim 16, wherein the UST setting is UST entry 125.

20. The computer-readable media of claim 19, wherein modifying the UST setting comprises changing the UST entry 125 between an on state and an off state, wherein:
when UST entry 125 is on the SIM performs the SUCI calculation; and
when UST entry 125 is off the UE performs the SUCI calculation.
